(19) United States
(12) Patent Application Publication
(10) Pub. No.: US 2005/0186938 A1
(43) Pub. Date: Aug. 25, 2005

(54) SYSTEM AND APPARATUS FOR LOCATING LOST PERSONS OR ANIMALS

(75) Inventor: Christopher Hunter, Vienna, VA (US)

Correspondence Address: BUCHANAN INGERSOLL, P.C., ONE OXFORD CENTRE, 301 GRANT STREET, 20TH FLOOR, PITTSBURGH, PA, 15219, US

(73) Assignee: FELLOWSHIP TECHNOLOGIES, INC., Vienna, VA (US)

(21) Appl. No.: 10/708,337

(22) Filed: Feb. 25, 2004

(51) Int. Cl. H04M 1/00

(52) U.S. Cl. 455/404.2; 455/456.1

(57) ABSTRACT

A network of receiving stations receives encoded signals from portable radio transmitters that are either hand held or implantable into the body. Each of the radio transmitters has a unique identification number associated with it that is transmitted as part of the signal. It is possible to estimate the location of any single transmitter by figuring out the bearing and range of the transmitters from one or more receiving stations based on signal strength as received by the stations. Because each transmitter has a unique identification number, it is possible to track the location of, for example, kidnapped children, by listening for a signal containing a specific identification number.

### FIELD OF THE INVENTION

This invention relates to the problem of tracking the location of moving objects, in this case, a person or an animal, utilizing a beacon-type radio frequency transmitter having a unique, personal identification number encoded therein.

### BACKGROUND OF INVENTION

It is well known in the art to electronically track persons or objects utilizing a transmitter or transponder, which typically communicates via radio frequencies and which can be embodied in handheld, wearable, or implantable versions. Such devices are useful for tracking humans for a variety of reasons, for example, for secure access to buildings or areas of buildings, for tracking of children in the case of kidnappings, for gathering medical telemetry and applying therapy, for the monitoring of persons under house arrest and for tracking persons engaged in hazardous activities, such as miners. Such systems use a variety of technologies, including, for example, GPS, radio frequency, cellular phone technology, etc.

Some examples of U.S. Patents disclosing prior art systems include: U.S. Pat. No. 6,169,484 (Schuchman, et al.) which discloses a system wherein a person is provided with a personal radio frequency transponder having a digital electronic identification number associated therewith, which is transmitted upon request from an interrogation unit; U.S. Pat. No. 6,362,778 (Neher) which discloses the use of a portable housing containing a GPS locator device which is worn on the wrist of a person like a wristwatch, and which, upon receipt of a location request signal, transmits the location to a central station for monitoring; U.S. Pat. No. 6,539,393 (Kabala), which discloses the use of portable wireless transmitters which transmit identification codes and portable wireless transceivers for collecting the identification codes. Also known in the art are systems which include implanted radio frequency devices, for example, U.S. Pat. No. 5,692,678 (Gargano, et al.) which discloses an implantable transceiver which incorporates a power supply and an actuation system which allows the unit to be either remotely actuated or actuated by the implantee; U.S. Pat. No. 6,034,622 (Levine) which discloses an implantable internal radio transmitter having unique identification information which is transmit to a network of external radio receivers and U.S. Pat. No. 5,735,887 (Barreras, Sr., et. al) which discloses an implantable electrically operated device utilizing radio frequency to transmit medical telemetry and to receive instructions regarding the delivery of medical therapy by the implanted device.

Many systems are also known for the tracking of various types of objects other than humans, such as, for example, cell phones (U.S. Pat. No. 6,674,403), stolen currency (U.S. Pat. No. 5,657,026), luggage (U.S. Pat. No. 6,147,602), pets (U.S. Pat. Nos. 6,067,018 and 6,441,788) and vehicles (U.S. Pat. Nos. 6,446,049 and 5,635,693). Most of these type systems communicate through the transmission of a radio frequency to some type of receiver, which can use a variety of means for discerning the location of the object based on the reception of the radio frequency signals.

### SUMMARY OF INVENTION

The invention disclosed herein provides a system for the locating and/or tracking of specific portable radio frequency transmitters uniquely associated with a single person, The systems includes the radio transmitters, which consist of a portable radio frequency transmitter embodied as a small pen-shaped unit which can be carried on a keychain or in the user's pocket or purse or an implantable device which can conveniently be implanted subdermally, a network of receiving stations for the reception of radio frequency signals transmitted by the portable units, and a central monitoring station for providing information regarding the person associated with a particular radio frequency transmitter. Because only a rough estimate of the location of any particular transmitter can be ascertained solely based on the reception of one its transmitted signal, a handheld receiving unit is also provided which can be used to locate the transmitter when in closer proximity to it.

The system is particularly useful in limited geographical areas. For example, the system may be used on college campuses as a “help needed” device, which can be activated by a person experiencing threatening situations or being physically attacked. The system would also be useful on battlefields to identify missing or injured soldiers and, in fact, one embodiment of the invention utilizes mobile receivers which can be moved in close proximity to strategic battle areas to locate injured soldiers. Additionally, the system may be useful in discovering the location of hostages or prisoners of war. The applications for the system are not limited, however, to applications in limited geographical areas, but may also be deployed in a wide geographical areas, for example, as a means of finding missing or kidnapped children who have been implanted with a sub dermal transmitter.

### BRIEF DESCRIPTION OF DRAWINGS

FIG. 1 is a schematic diagram of the portable hand held radio transceiver.

FIG. 2 shows a likely embodiment of the portable hand held radio transmitter.

FIG. 3 shows an embodiment of the implantable radio transmitter.

FIG. 4 is a schematic diagram of the computer system at the receiving antenna site.

FIG. 5 is a schematic diagram of the hand held locator scanner.

FIG. 6 is an overall view of an embodiment of the locator scanner.

FIG. 7 shows the topology of a system which could be used in a limited geographic area.

FIG. 8 shows the topology of a system which could be used in an unlimited geographic area.

FIG. 9 shows the topology of a system which could be used in a limited geographic area with mobile receivers.

FIG. 10 shows the reception of a signal by multiple receivers and the process of finding the source of the signal by triangulation.

### DETAILED DESCRIPTION OF THE DRAWINGS

The system of the present invention includes several components. These include primarily the radio frequency transmitter, which can be either a portable hand-held device or a device which can be implanted under the skin of a person or an animal, one or more radio receiving stations consisting of a receiving antenna and a computer to process the received signals, a central station connected to the receiving stations by some means, preferably standard internet connection, and a database at the central station containing the names and other demographic information of the persons or objects associated with the radio transmitters.

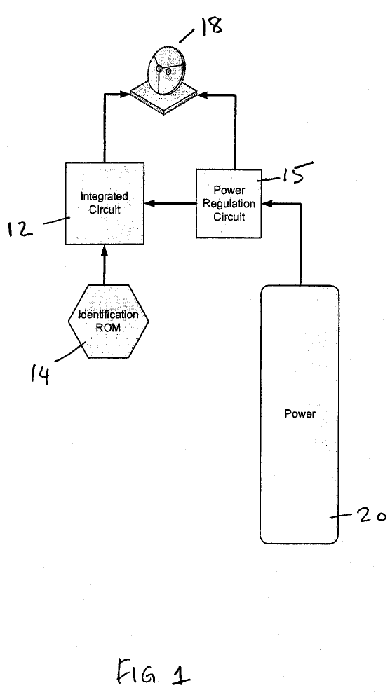

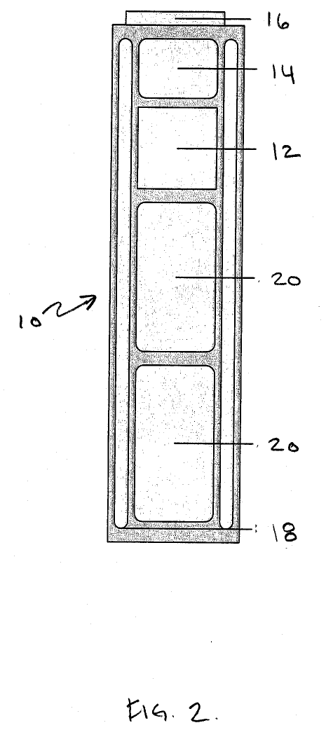

The hand held portable transmitter 10 is shown schematically in FIG. 1 and as it is embodied in the invention in FIG. 2. Transmitter 10 is preferably the size of a wide ball point pen which may be fitted with a ring to allow the person to carry it on a key chain. The device is triggered by activating switch 16. The device is powered by batteries 20, which, in the preferred embodiment may be commonly available AA size batteries. Power regulation circuit 15 regulates the power drawn from batteries 20 and powers both radio transmitter 18 and integrated circuit 12. Integrated circuit 12 reads a unique identification code from ROM 14 and formats message which is sent to the radio transmitter 18 for transmission via a radio frequency signal on a periodic basis. In a preferred embodiment, transmitter 10 broadcasts its signal once every five seconds until the device is either turned off or until the unit runs out of power, but the period of the transmission may vary. Each transmitter 10 is provided with identification ROM 14 having a unique identification number encoded therein which is programmed prior to the unit being distributed to the end user. The broadcast signal consists of a digital encoding of the unique identification number. Transmitter 10 preferably transmits at a power similar to a standard cellular telephone, but, in other embodiments, may transmit a much more powerful signal capable of reaching GPS satellites.

Hand held transmitter 10 is useful in an application in a limited geographic area, such as on a college campus, where a person carrying the receiver may send a signal that help is needed when faced with a threatening situation or when otherwise in a distressed state, such as may happen if the person is physically attacked or has a medical emergency.

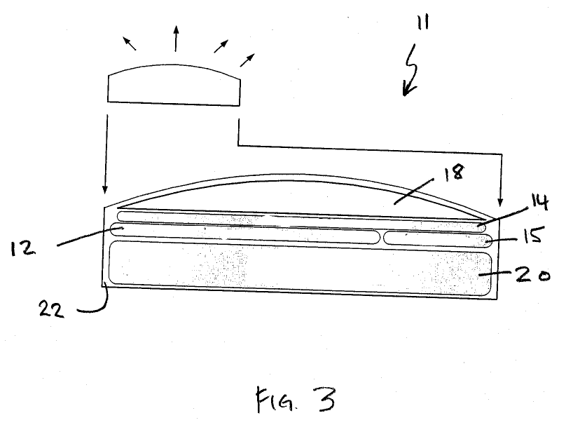

Sub-dermal transmitter 11 is shown in FIG. 3. Transmitter 11 has the same basic components as hand held transmitter 10, however, the components are much smaller such that the transmitter 11 may be inserted subdermally using a special syringe. Preferably the unit is approximately 15 millimeters in diameter or less and has a thickness of 3 millimeters or less and is preferably encased in a polymer shield 22 to protect the unit from the harsh environment inside the body. The device is preferably inserted subdermally at a location on the upper portion of the body, such as on the shoulder or upper back, such that the transmitted radio signals are able to reach a receiving antenna. Transmitter 11 is also an active unit and will produce a periodic signal at all times. Preferably power supply 20 is a battery which may be recharged through the skin by a recharger of the type typically used to charge batteries in pacemakers. Because of power considerations, the periodic signal of the sub-dermal unit is sent less frequently than that of the hand held unit, preferably approximately once every minute.

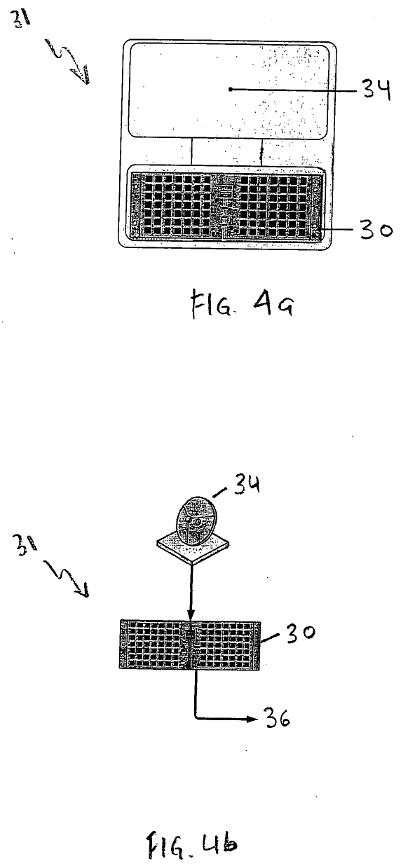

The receiving stations 31, shown schematically in FIG. 4, receive signals from either hand held transmitter 10 or sub-dermal transmitter 12 and should be located at varying geographic distances from each other, based primarily on the terrain of the land. For an application in a limited geographic area such as at a college campus, receiving stations 31 can be placed on the far edges of the campus, on buildings or on other structures. When used in a wide area application, it would be convenient if receiving stations were placed coincidentally with cellular telephone towers, with antennas 34 perched high on the tower to cover the largest possible geographic area. [

Receiving station 31 consists of a receiving antenna 34 and a computer 30, as shown in FIG. 4. Computer 30 is connected to the outside world by connection 36, which is preferably a connection to the Internet to enable it to communicate with other computers via standard TCP/IP formatted messages or, in an alternative, a direct dial capability such that connections may be established with the outside world. Receiving station 31 would have the capability to both send and receive messages via connection 36.

Another embodiment of the invention, signals transmitted by hand held transmitter 10 or sub-dermal transmitter 11 may be directed to a GPS or other type of communication satellite, which may relay the message to an earth-bound receiving station 31, or otherwise deliver the message via some other means.

In operation, radio antenna 34 of receiving station 31 will receive a signal from an active transmitter 10 or 11 and determine the direction and range of the transmitter from the station based on the strength of the signal. Location information can be expressed in either a convenient X-Y format or as coordinate expressed as standard latitude and longitude. Computer 30 is also able to decode the received signal to determine the unique identification code encoded therein. Computer 30 then passes the location information, along with the unique identification number, to a central 68 station via connection 36.

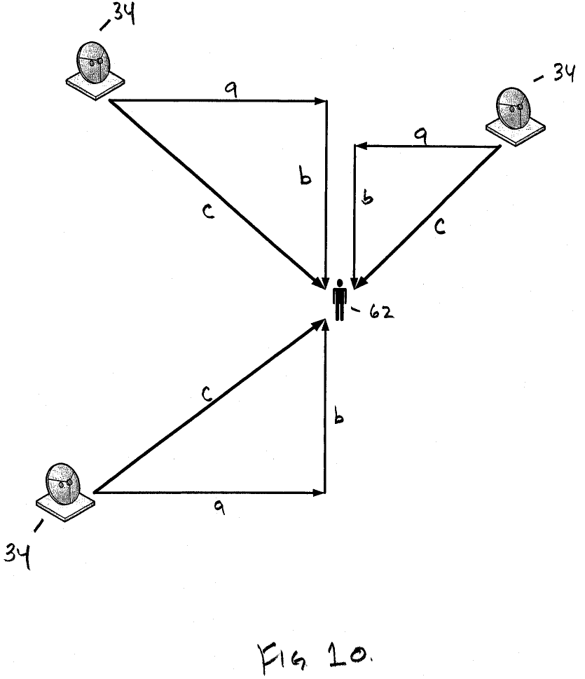

The power output of hand held transmitter 10 would be approximately equivalent to that of a cellular telephone, while the power output of sub-dermal transmitter 11 is likely to be much less because of the continuous nature of the broadcasting of the periodic signals. The accuracy of the location determining capabilities will vary based on signal strength and terrain. However, it is estimated that with a single receiving station 31, the capability will exist to locate transmitter 10 or 11 within approximately 100 meters. Naturally, if the signal is being received by multiple receiving stations 31, as is shown in FIG. 10, the accuracy of the location estimate will improve.

The triangulation process shown in FIG. 10 is well known in the prior art. Multiple receiving stations 31 receive a signal C from a person 62 with a transmitter and are able to estimate distances A and B based on the direction and strength of the signal received from transmitter 62. It should be noted that the more stations 31 receiving the signal C, the more accurate the estimate of location as the location estimate will be more dependant upon direction rather than strength of signal. This is desirable because the strength of the signal may vary depending upon obstructions between transmitter 62 and receiving station 31 such as terrain or buildings.

Central monitoring station 68 receives messages from each of receiving stations 31 which are currently receiving a signal from transmitter 10 or 11. Central monitoring station 69 consists of a desk top computer or server running an operating system which can accept incoming messages over an internet connection using the TCP/IP protocol, such as Windows XP, Windows 2003 server or Linux, from the various receiving stations 31. Central monitoring station 68 is provided with a database 70 in the computer which contains the name, as well as other demographic type data, such as phone number and address, of the person to whom transmitter 10 or 11 has been assigned. Database 70 is preferably keyed by identification number.

In the case of an application wherein portable hand held transmitters 10 are in use, such as on a college campus, the receipt of a signal from one of the transmitters indicates a person in distress, whereas in a situation utilizing sub-dermal transmitters 11, all identification numbers from all units in the area are being received simultaneously. In this case, it is possible for the central monitoring station 68 to indicate to receiving stations 31 to filter out all but one of the unique identifying numbers. This would be used in an application, for example, where a child with a sub-dermal transmitter is kidnapped and the authorities are informed and instruct the system to look for the particular identification number of the kidnapped child.

Additionally, it is possible that a sub-dermal transmitter 11 may wander into an area where a limited application is in use, or, conversely, a person with a hand held transmitter 10 would activate the transmitter in an area in which constantly transmitting units are in use. In the first case, false alarms would result, while, in the second case, a call for help from a distressed person would be lost among the hundreds or thousands of other signals being received by receiving stations 31. Therefore, it is necessary to be able to distinguish between the two types of transmitters. This can be accomplished by having certain identification numbers assigned to each type of transmitter, or by having the different types of transmitters transmit on different frequencies.

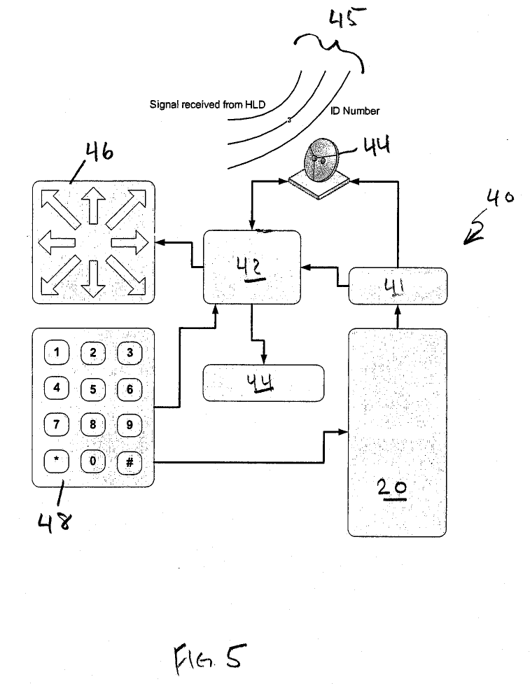

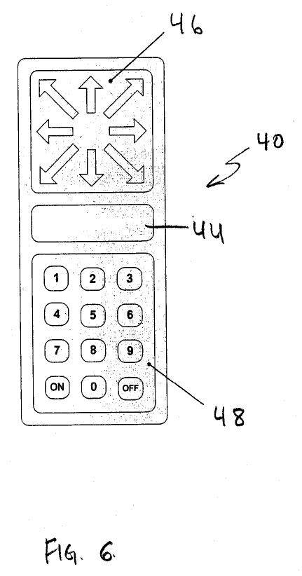

Once a rough estimate of the location of a particular transmitter 10 or 11 is determined, help can be dispatched to that location and transmitter 10 or 11 can be more accurately located using hand held scanner 40, which is shown in schematic form and in one possible embodiment in FIGS. 5 and 6 respectfully. Hand held scanner 40 consists of power supply 20 along with power distribution chip 41, which provides power to integrated circuit 42 and receiving antenna 44. It is equipped with an LCD screen 44 and keypad 48, along with direction indicator 46. In operation, the particular unique identification number of interest is keyed into key pad 48. When receiving a signal 45 from transmitter 10 or 11, direction indicator 46 will point in the specific direction from the present location to where transmitter 10 or 11 is located. LCD screen 44 is used to provide range and status information and other feedback information. Based on the information provided by the unit, the user of hand held scanner 40 should be able to move in the direction of the particular transmitter 10 or 11 until it is discovered.

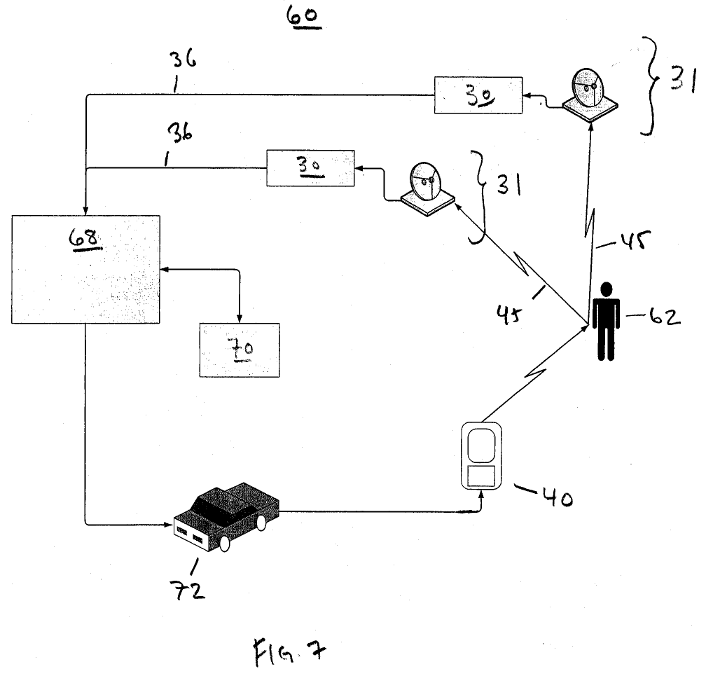

FIG. 7 shows a typical application in a limited geographical area, such as at a college campus, where person 62 carrying portable hand held unit 10 may indicate a distressed condition either as a result of a physical attack or a medical condition by activating transmitter 10 by depressing button 16. The same set up can be used, in other setting as well, such as, for example, in a retirement community situation where people may call for medical help when it is needed. In operation, person 62 activates their portable hand held transmitter 10 and signal 45 is thereafter periodically transmitted to receiving antennas 34 at receiving stations 31. As discussed previously, based on the direction and signal strength of the received signal, computers 30 are able to provide an estimate of the location of person 62. The estimate, as well as the unique identification number of portable hand-help transmitter 10 of person 62, is sent via TCP/IP or other means of transmitting messages 36 to a central monitoring station 68, which in the case of a college campus, will most likely be the campus security office. The receiving computer at central monitoring station 68 would look up the name of person 62 as well as other information in database 70. At this point several actions may be taken, it is possible that if person 62 is located in his or her residence, a phone call may be placed to the residence to determine if the signal being sent is a false alarm. If not, unit 72 may be dispatched to the general area where person 62 is located and thereafter hand held scanner 40 may be used to physically locate person 62.

Note that it is possible that the identification number of the person is not found in the local database 70. Such as would be the case if person 62 was not a member of the community where the system was implemented. In this case, a program running on the computer in central monitoring station 68 may contact the computer of the manufacturer via an online to locate the name, address and phone number of the owner of hand held transmitter 10. This situation may arise, for example, if the person is a visitor to the campus and happens to also have a portable hand held device 10 or if a person with an embedded transmitter 11 happens to be in the vicinity of a campus where the application is in place.

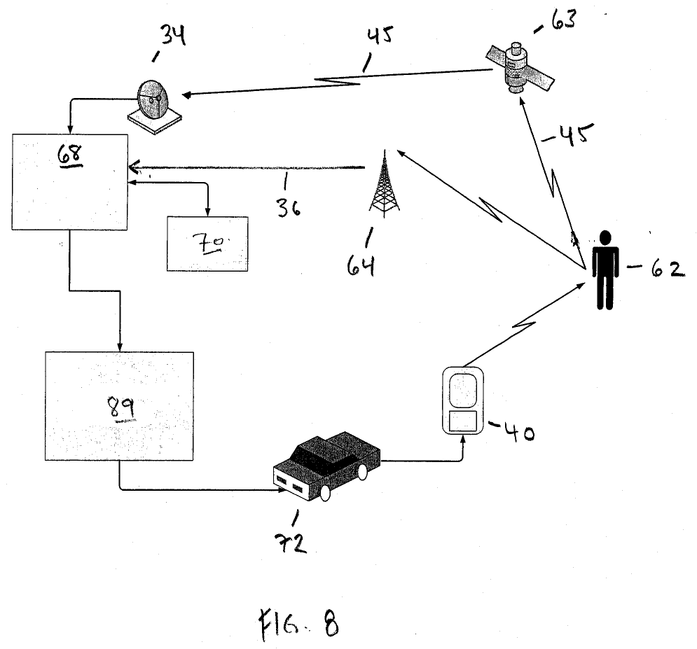

FIG. 8 shows an application in use in a wider area. In this case, person 62 activates hand held transmitter 10 which causes signal 45 to be sent to either receiving station 31 preferably located at a cellular tower 64 (or other structure) or to a GPS satellite 62, or to both. If signal 45 is sent to GPS satellite 62, satellite 62 is able to relay signal 45 to a ground-based receiving station 31 via receiving antenna 34, preferably located at a central monitoring station 68. Receiving station 31 located at tower 64 is typical receiving station 31 as shown in FIG. 4, and sends the location and identification number to central monitoring station 68 via TCP/IP message 36. Central monitoring station 68 receives all of the data from every tower or satellite which is receiving a signal from persons 62 and is able to combine the X-Y coordinates from each of the towers or satellites receiving the signal to form a precise location of person 62. As in the campus application, the identification number is checked against database 70 containing locally known persons having transmitters 10. The signal can then be dispatched to local law enforcement 89 to dispatch unit 72 to the general vicinity of person 62 wherein after a hand held scanner 40 may be used to precisely locate person 62.

In the case where sub-dermal transmitters 11 are in use, in which all transmitter are constantly transmitting a periodic signal, receiving stations 31 can be instructed to look for a specific identification number and to filter out all other numbers. In this case, all receiving stations 31 receiving the particular identification number of interest will report to central monitoring station 68.

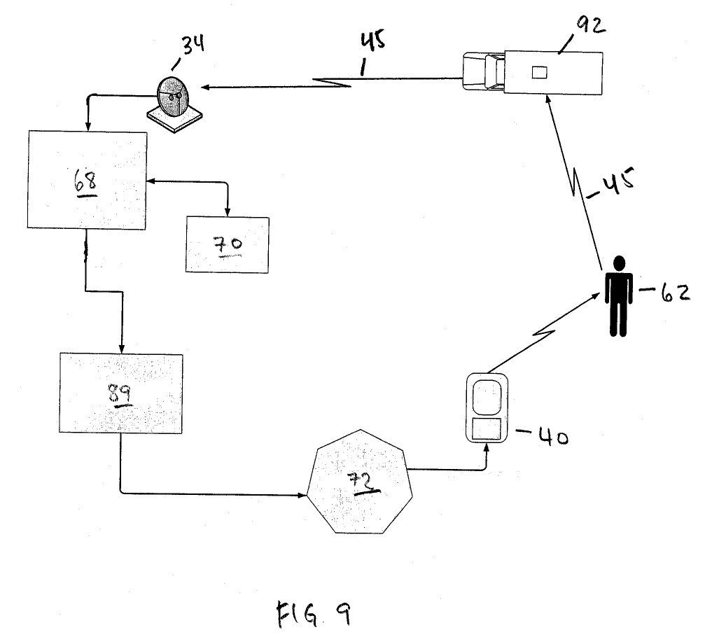

FIG. 9 shows a war theatre or a battlefield scenario wherein soldier 62 may have a sub dermal transmitter 11 which is periodically and continuously transmitting signal 45. When the soldier is injured, captured, taken hostage or otherwise disabled, mobile receiving units 92 may be driven into the local area to receive signal 45 from the sub dermal transmitters 11. Signal 45 is relayed from mobile receiving station 92 to a central monitoring station 68 via antenna 34. Central monitoring station 68 has a database 70 containing the name and other demographic information regarding the soldier person 62 . Once solider 62 is located by central monitoring station 68, a message can be sent to central command 89 and rescue unit 72 can be dispatched to rescue soldier 62 . The precise location of solider 62 is determined using hand held scanner 40. Note that this application is not limited to a battlefield or war theater scenario, but may be utilized in other areas, for example, in urban areas.

While specific embodiments of the present invention have been used in an exemplary manner, this is not meant to limit the scope of the invention, which is defined by the claims which follow.

1. A system for locating a radio transmitter comprising one or more antennas for receiving a signal from said radio transmitter, said signal containing an encoded identification number unique to said transmitter;
a computer running a program for estimating the bearing and range of said radio transmitter from said antenna based on the signal strength of said signal; and
a means for sending a message containing said estimated bearing and range information and said unique identification number when said signal is detected:

2. The system of claim 1 further comprising a database indexed by said unique identification number containing demographic information of persons or objects associated with specific ones of said radio transmitters.

3. The system of claim 2 further comprising a computer for receiving said message containing said estimated bearing and range information and said unique identification number.

4. The system of claim 3 wherein said computer sending said message and said computer receiving said message communicate via a standard internet connection and wherein said messages utilize the TCP/IP protocol.

5. The system of claim 3 wherein more than one of said one or more antennas receives said signal and sends said message and further wherein said computer receiving said messages combines said estimated bearing and range information to form a better estimate of the location of said transmitter.

6. The system of claim 5 wherein a triangulation algorithm is used to form said estimate of said location.

7. The system of claim 6 wherein a plurality of said radio transmitters are transmitting at any given time further comprising a means for discriminating between said transmitted signals.

8. The system of claim 7 wherein said means for discriminating between said signals is a filter that filters out certain of said unique identification numbers or a range of said unique identification numbers.

9. The system of claim 7 wherein said one or more transmitters transmits on different frequencies.

10. The system of claim 6 further comprising:
a means for receiving a message containing a unique identification number; and
a means for discriminating between signals transmitted by said plurality of said transmitters such that the location of a single transmitter transmitting a message containing said received unique identification number can be determined.

11. The system of claim 10 wherein said transmitters periodically transmit said signal containing said unique identification number.

12. The system of claim 10 wherein said received signal has been relayed by an orbital satellite

13. The system of claim 11 wherein said transmitters are portable units having an on/off switch and wherein said transmitters periodically transmit said signal after said on/off switch has been activated.

14. The system of claim 1 wherein said one or more antennas are mobile.

15. A method for determining the location of a radio transmitter comprising the steps of:
receiving, with an antenna, a signal from said radio transmitter, said signal containing an encoded identification number unique to said transmitter;
estimating the bearing and range of said radio transmitter from said antenna based on the signal strength of said signal; and
sending a message containing said estimated bearing and range information and said unique identification number when said signal is detected.

16. The method of claim 15 further comprising the step of querying a database using said unique identification number to determine a person or object associated with said radio transmitter

17. The method of claim 15 further comprising the step of:
receiving a plurality of messages containing said bearing and range information and said unique identification number and forming a more accurate estimate of the location of said radio transmitter using a triangulation algorithm.

18. The method of claim 17 further comprising the steps of:
dispatching a person to said estimated location of said radio transmitter; and
using a handheld receiver to pinpoint the location of said radio transmitter.

19. The method of claim 18 wherein said handheld receiver provides an indication of the bearing of said radio transmitter from the current location of said receiver

20. The method of claim 19 wherein said handheld receiver provides an indication of the distance of said radio transmitter from the current location of said receiver.

21. The method of claim 18 wherein said handheld receiver has a keyboard therein for inputting of the unique identification number of the radio transmitter from which signals are to be received.

22. The method of claim 15 wherein said signals are received from a plurality of radio transmitters further comprising the steps of:
filtering out transmissions from all but one of said radio transmitters; and
sending said message when a signal from said one radio transmitter is received.

23. A portable radio beacon comprising:
a power source;
circuitry, powered by said power source, for periodically transmitting a radio signal on a given frequency;
means for associating a unique identification number with said radio beacon, said radio signal containing said unique identification number.

24. The portable radio beacon of claim 23 further comprising an on/off switch for activating said circuitry.

25. The portable radio beacon of claim 23 further comprising a polymer shell encapsulating said radio beacon to protect said radio beacon from environmental hazards encountered when said radio beacon is implanted inside the body of a human or an animal.
